(19) United States
(12) Patent Application Publication
(10) Pub. No.: US 2013/0002008 A1
(43) Pub. Date: Jan. 3, 2013

(54) Brake Control Apparatus

(75) Inventor: Atsushi MATSUOKA, Hadano-shi (JP)

(73) Assignee: Hitachi Automotive Systems, Ltd., Hitachinaka-shi (JP)

(21) Appl. No.: 13/443,045

(22) Filed: Apr. 10, 2012

(30) Foreign Application Priority Data
Jun. 29, 2011 (JP) 2011-143648

(51) Int. Cl. B60T 13/58; B60T 13/74

(52) U.S. Cl. 303/3

(57) ABSTRACT

A brake control apparatus for a vehicle provided with a regenerative braking system includes a hydraulic circuit where a first passage connects a master cylinder to a wheel cylinder. A second passage connects a discharge side of a pump to a first portion of the first passage. A third passage connects a suction side of the pump to a second portion of the first passage between the master cylinder and the first portion. A fourth passage connects the suction side of the pump to a third portion of the first passage between an inflow valve and the wheel cylinder. A reservoir is disposed in a section of the fourth passage between the outflow valve and third passage. A cutoff valve in a section of the fourth passage between the reservoir and third passage operates depending on operation of the regenerative braking system.

### BACKGROUND OF THE INVENTION

The present invention relates to brake control apparatuses.

Japanese Patent Application Publication 2002-302031, which corresponds to U.S. Pat. No. 6,851,762, discloses a brake control apparatus which implements a brake boost function with two control valves for switching between two fluid passages leading to wheel cylinders, wherein one of the fluid passages is provided with a boost piston for boosting pressure of brake fluid discharged by a pump, and the other fluid passage is provided with no such boost piston.

### SUMMARY OF THE INVENTION

It is desirable to provide a brake control apparatus capable of performing a similar boost function with a simpler structure. It is also desirable to provide such a brake control apparatus based on an existing hydraulic pressure control unit.

According to one aspect of the present invention, a brake control apparatus for a vehicle provided with a regenerative braking system, the brake control apparatus comprises: a braking operation detecting section configured to detect a condition of driver's braking operation; a first brake fluid passage hydraulically connecting a master cylinder to a wheel cylinder, wherein the master cylinder generates a brake fluid pressure in response to driver's braking operation, and wherein the brake fluid pressure acts on the wheel cylinder; a pump configured to suck brake fluid from the master cylinder, and provided with a discharge-side valve on a discharge side of the pump; a second brake fluid passage hydraulically connecting the discharge side of the pump to a first connecting portion of the first brake fluid passage; a third brake fluid passage hydraulically connecting a suction side of the pump to a second connecting portion of the first brake fluid passage, wherein the second connecting portion is between the master cylinder and the first connecting portion; an inflow valve disposed in a section of the first brake fluid passage between the wheel cylinder and the first connecting portion of the first brake fluid passage; a fourth brake fluid passage hydraulically connecting a connecting portion of the third brake fluid passage to a third connecting portion of the first brake fluid passage, wherein the third connecting portion is between the inflow valve and the wheel cylinder; an outflow valve disposed in the fourth brake fluid passage; a reservoir disposed in a section of the fourth brake fluid passage between the outflow valve and the connecting portion of the third brake fluid passage; and a cutoff valve disposed in a section of the fourth brake fluid passage between the reservoir and the connecting portion of the third brake fluid passage, and configured to operate depending on a condition of operation of the regenerative braking system.

According to another aspect of the present invention, a brake control apparatus for a vehicle provided with a regenerative braking system, the brake control apparatus comprises: a braking operation detecting section configured to detect a condition of driver's braking operation; a first brake fluid passage hydraulically connecting a master cylinder to a wheel cylinder, wherein the master cylinder generates a brake fluid pressure in response to driver's braking operation, and wherein the brake fluid pressure acts on the wheel cylinder; a pump configured to suck brake fluid from the master cylinder, and provided with a discharge-side valve on a discharge side of the pump; a second brake fluid passage hydraulically connecting the discharge side of the pump to a first connecting portion of the first brake fluid passage; a third brake fluid passage hydraulically connecting a suction side of the pump to a second connecting portion of the first brake fluid passage, wherein the second connecting portion is between the master cylinder and the first connecting portion; an inflow valve disposed in a section of the first brake fluid passage between the wheel cylinder and the first connecting portion of the first brake fluid passage; a fourth brake fluid passage hydraulically connecting a connecting portion of the third brake fluid passage to a third connecting portion of the first brake fluid passage, wherein the third connecting portion is between the inflow valve and the wheel cylinder; an outflow valve disposed in the fourth brake fluid passage; a reservoir disposed in a section of the fourth brake fluid passage between the outflow valve and the connecting portion of the third brake fluid passage, and configured to receive inflow of brake fluid flown out of the master cylinder through the inflow valve and the outflow valve; and a cutoff valve disposed in a section of the fourth brake fluid passage between the reservoir and the connecting portion of the third brake fluid passage, and configured to allow the reservoir to store brake fluid flown into the reservoir, by cutting off hydraulic connection between the reservoir and the third brake fluid passage.

According to a further aspect of the present invention, a brake control apparatus for a vehicle provided with a regenerative braking system, the brake control apparatus comprises: a braking operation detecting section configured to detect a condition of driver's braking operation; a first brake fluid passage hydraulically connecting a master cylinder to a wheel cylinder, wherein the master cylinder generates a brake fluid pressure in response to driver's braking operation, and wherein the brake fluid pressure acts on the wheel cylinder; a pump configured to suck brake fluid from the master cylinder, and provided with a discharge-side valve on a discharge side of the pump; a second brake fluid passage hydraulically connecting the discharge side of the pump to a first connecting portion of the first brake fluid passage; a third brake fluid passage hydraulically connecting a suction side of the pump to a second connecting portion of the first brake fluid passage, wherein the second connecting portion is between the master cylinder and the first connecting portion; an inflow valve disposed in a section of the first brake fluid passage between the wheel cylinder and the first connecting portion of the first brake fluid passage; a fourth brake fluid passage hydraulically connecting a connecting portion of the third brake fluid passage to a third connecting portion of the first brake fluid passage, wherein the third connecting portion is between the inflow valve and the wheel cylinder; an outflow valve disposed in the fourth brake fluid passage; a reservoir disposed in a section of the fourth brake fluid passage between the outflow valve and the connecting portion of the third brake fluid passage, and configured to receive inflow of brake fluid flown out of the master cylinder through the inflow valve and the outflow valve; and a flow control section to configured to suppress brake fluid from flowing out of the reservoir to the third brake fluid passage, in response to presence of operation of the regenerative braking system.

### BRIEF DESCRIPTION OF THE DRAWINGS

FIG. 1 is a schematic diagram showing a brake is system of a motor vehicle provided with a brake control apparatus according to a first embodiment of the present invention.

FIG. 2 is a schematic diagram showing a hydraulic circuit of the brake control apparatus.

FIG. 3 is a control block diagram showing a function of cooperative regenerative braking control of a brake control unit of the brake control apparatus.

FIG. 4 is a flow chart showing a process of reservoir fluid quantity control performed by the brake control unit during the cooperative regenerative braking control.

FIGS. 5A and 5B are time charts showing how three kinds of braking force (driver request braking force, regenerative braking force and frictional braking force) change with time during a period of time from a time instant when a brake pedal starts to be depressed down by a driver to a time instant when a vehicle comes to a halt.

FIG. 6 is a schematic diagram showing how a hydraulic pressure control unit operates and brake fluid flows in the hydraulic circuit at a beginning of braking operation.

FIG. 7 is a schematic diagram showing how the hydraulic pressure control unit operates and brake fluid flows in the hydraulic circuit at a stage of increase of braking force.

FIG. 8 is a schematic diagram showing how the hydraulic pressure control unit operates and brake fluid flows in the hydraulic circuit at a stage of increase of regenerative braking force.

FIG. 9 is a schematic diagram showing how the hydraulic pressure control unit operates and brake fluid flows in the hydraulic circuit at a stage of termination of regenerative braking operation.

FIG. 10 is a schematic diagram showing a hydraulic circuit of a brake control apparatus according to a second embodiment of the present invention.

FIG. 11 is a schematic diagram showing a hydraulic circuit of a brake control apparatus according to a third embodiment of the present invention.

FIG. 12 is a control block diagram showing a function of cooperative regenerative braking control of a brake control unit of a brake control apparatus according to a fourth embodiment of the present invention.

### DETAILED DESCRIPTION OF THE INVENTION

### First Embodiment

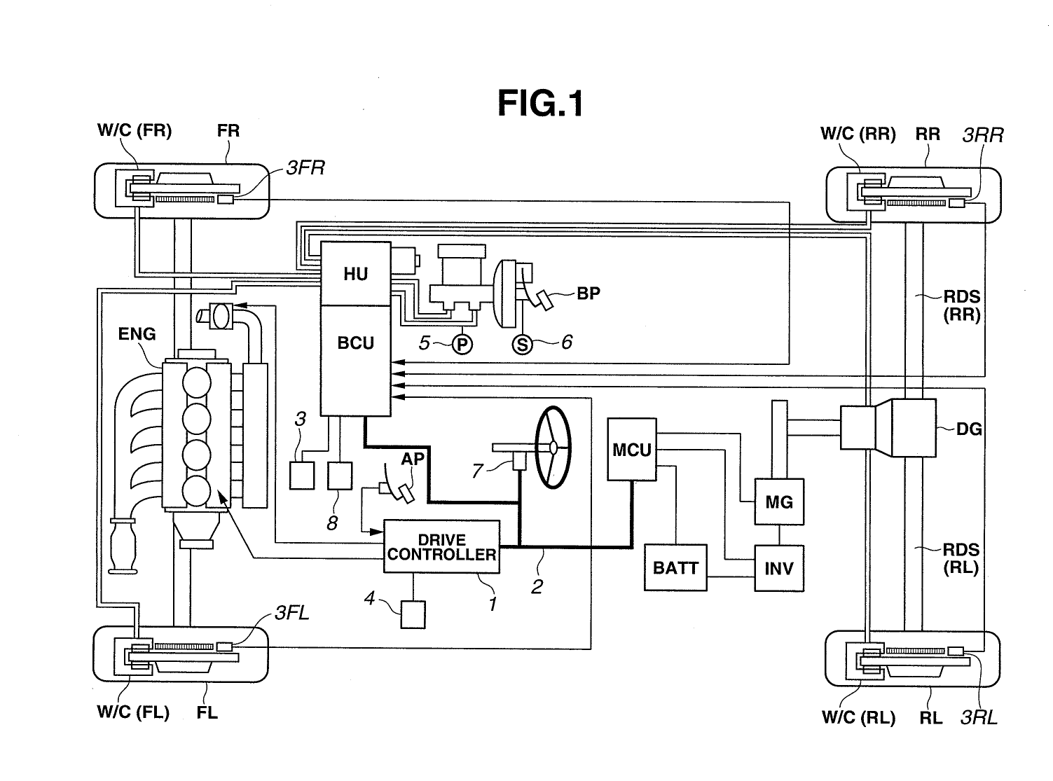

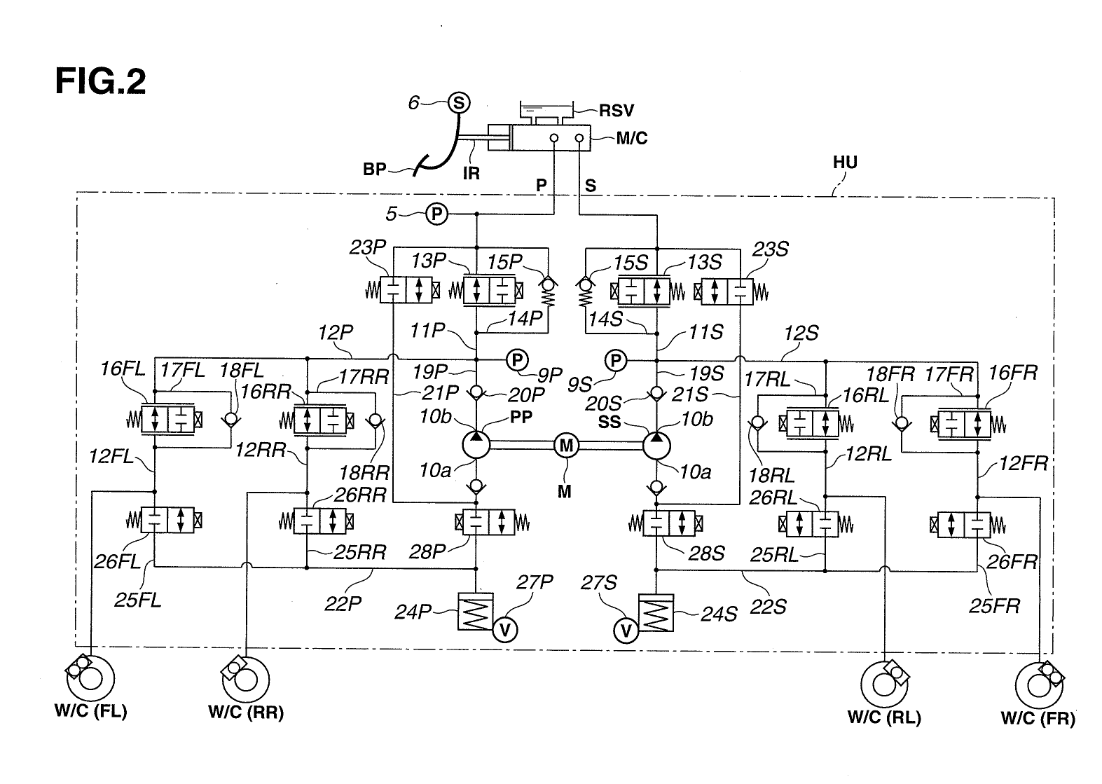

FIG. 1 schematically shows a brake system of a motor vehicle provided with a brake control apparatus according to a first embodiment of the present invention. FIG. 2 schematically shows a hydraulic circuit of the brake control apparatus.

<System Configuration> In response to a command signal from a brake control unit BCU as a brake fluid pressure control section, a hydraulic pressure control unit HU increases or reduces or holds the internal pressure of each of a left front wheel cylinder W/C(FL) at a left front road wheel FL, a right front wheel cylinder W/C(FR) at a right front road wheel FR, a left rear wheel cylinder W/C(RL) at a left rear road wheel RL, and a right rear wheel cylinder W/C(RR) at a right rear road wheel RR.

A motor generator MG is a three-phase alternating-current motor. Motor generator MG is coupled to a left rear drive shaft RDS(RL) for left rear road wheel RL and a right rear drive shaft RDS(RR) for right rear road wheel RR through a differential gear DG. Motor generator MG rotates in power run state or in regeneration run state, and applies to left and right rear road wheels RL, RR driving forces or regenerative braking forces, depending on a command from a motor control unit MCU.

An inverter INV receives a command signal from motor control unit MCU, and performs based on the command signal a conversion to an alternating current from a direct current supplied from a battery BATT, and supplies the converted current to motor generator MG so that motor generator MG rotates under power. On the other hand, in response to a command signal from motor control unit MCU, inverter INV allows motor generator MG to run in regenerative mode, by performing a conversion to a direct current from an alternating current generated at motor generator MG, and supplying the converted current to battery BATT for charging the same.

Motor control unit MCU receives a command signal from a drive controller 1, and outputs to inverter INV a command signal that is generated depending on the received command signal. In response to a command signal from brake control unit BCU, motor control unit MCU outputs a command signal to inverter INV. Motor control unit MCU sends information to brake control unit BCU and drive controller 1 through a communication line 2, wherein the information includes a condition of output control of driving torque or regenerative braking torque of motor generator MG, and an upper limit of regenerative braking torque generated by motor generator MG (or an upper limit of regenerative braking force at road wheels). This upper limit may be calculated based on an estimated value of a battery SOC (state of charge) which is obtained with reference to the terminal voltage and current of battery BATT, and based on an estimated or calculated value of vehicle body speed or vehicle speed. When the vehicle is turning, the upper limit may be calculated in account of steer characteristics of the vehicle. Specifically, when the battery SOC is at or close to a full level, the upper limit is set in consideration of preventing the battery BATT from being overcharged, and thereby protecting the battery BATT. When the vehicle is decelerated by braking, the maximum possible value of regenerative braking force decreases as the vehicle speed decreases. On the other hand, when the vehicle is traveling at high speed, regenerative braking operation may cause a high load applied to inverter INV. In view of the foregoing, the upper limit of regenerative braking force is set for protection of inverter INV.

The setting of the upper limit of regenerative braking force is further advantageous as follows. In the case of the vehicle according to this embodiment, regenerative braking torque is applied to the rear wheels. If the regenerative braking force is excessively higher than the frictional braking force when the vehicle is turning, namely, if the total braking force of rear wheels is excessively higher than the total braking force of front wheels, the vehicle may be fall in oversteer tendency, so that turning behavior of the vehicle may become unstable. In such situations, it is desirable to conform braking force distribution between the front side and the rear side during turning to an ideal one determined by specifications of the vehicle (front:rear=6:4, for example). This problem is solved by the setting of the upper limit of regenerative braking force in this embodiment. Motor generator MG, inverter INV, battery BATT, and motor control unit MCU constitute a regenerative braking system for producing a regenerative torque at left and right rear road wheels RL, RR. Drive controller 1 receives information from various sensors, and performs various control operations depending on the received information, wherein the control operations include a control operation of controlling operation of an automatic transmission not shown, and a control operation of controlling operation of motor generator MG by outputting a drive command to motor control unit MCU.

Brake control unit BCU receives input of information from various sensors directly or through the communication line 2. The sensors include a master cylinder pressure sensor 5 as a braking operation detecting section for obtaining and providing information about master cylinder pressure, and a brake pedal stroke sensor 6 as a braking operation detecting section for obtaining and providing information about brake pedal stroke, and a steering wheel angle sensor 7 for obtaining and providing information about steering wheel angle, and a road wheel speed sensor 3 for obtaining and providing information about road wheel speeds, and a yaw rate sensor 8 for obtaining and providing information about vehicle body yaw rate, and a wheel cylinder pressure sensor 9 for obtaining and providing information about wheel cylinder pressure. Brake control unit BCU also receives input of information about battery SOC, etc., through the communication line 2.

Brake control unit BCU is configured to calculate or estimate a driver request value of braking force, based on information about master cylinder pressure and brake pedal stroke. Brake control unit BCU allocates the driver request value of braking force to a component of regenerative braking force and a component of frictional braking force, and controls operation of hydraulic pressure control unit HU to achieve a desired frictional braking force, and outputs a command signal to motor control unit MCU to control operation of motor generator MG to achieve a desired regenerative braking force.

In the present embodiment, a cooperative regenerative braking control is performed in which regenerative braking is prioritized higher than frictional braking so that if a driver request of braking force can be fulfilled by regenerative braking force, brake control unit BCU uses regenerative braking force only, as long as the driver requests is below the upper limit of regenerative braking force. This serves to enhance energy recovery efficiency overall from a low speed region to a high sped region, especially when the vehicle accelerates and decelerates repeatedly. When the vehicle speed decreases or increases so that the regenerative braking force is limited to the upper limit, brake control unit BCU decreases the distribution for regenerative braking force and increases the distribution for frictional braking force, for achieving the driver request. On the other hand, when the upper limit of regenerative braking force is raised to allow a relatively large regenerative braking force, brake control unit BCU increases the distribution for regenerative braking force and decreases the distribution for frictional braking force.

<Hydraulic Circuit> The following describes specific configuration of hydraulic pressure control unit HU. Hydraulic pressure control unit HU has an X-line arrangement including a P-line section and a S-line section. The P-line section is hydraulically connected to left front wheel cylinder W/C(FL) and right rear wheel cylinder W/C(RR), whereas the S-line section is hydraulically connected to right front wheel cylinder W/C(FR) and left rear wheel cylinder W/C(RL). In FIG. 2, each reference symbol having a last character of “P” represents an element associated with the P-line section, whereas each reference symbol having a last character of “S” represents an element associated with the S-line section. Similarly, each reference symbol having last two characters of “FL” represents an element associated with left front road wheel FL, and each reference symbol having last two characters of “FR” represents an element associated with right front road wheel FR, and each reference symbol having last two characters of “RL” represents an element associated with left rear road wheel RL, and each reference symbol having last two characters of “RR” represents an element associated with right rear road wheel RR. In the following description, these last characters are omitted if the described feature is common between the P-line section and S-line section or among road wheels FL, FR, RL and RR for conciseness of the description.

Hydraulic pressure control unit HU employs a closed hydraulic circuit, which is a hydraulic circuit in which brake fluid supplied to wheel cylinder W/C is returned to reservoir tank RSV through master cylinder M/C. Incidentally, in contrast to such a closed type hydraulic circuit, an open type hydraulic circuit is a hydraulic circuit in which brake fluid supplied to a wheel cylinder can be returned directly to a reservoir tank without passing through a master cylinder. Brake pedal BP is coupled to master cylinder M/C through an input rod IR.

The P-line section is provided with a pump PP, whereas the S-line section is provided with a pump PS. Each pump PP, PS is a gear pump, and is driven by a common electric motor M, and is configured to suck brake fluid through a suction port 10a, and pressurize and discharge brake fluid through a discharge port 10b.

Master cylinder M/C and each wheel cylinder W/C are connected to each other through a fluid passage 11 and a fluid passage 12. Fluid passage 12P braches into a fluid passage 12FL and fluid passage 12RR, wherein fluid passage 12FL is hydraulically connected to left front wheel cylinder W/C(FL), and fluid passage 12RR is hydraulically connected to right rear wheel cylinder W/C(RR). On the other hand, fluid passage 12S branches into a fluid passage 12FR and fluid passage 12RL, wherein fluid passage 12FR is hydraulically connected to right front wheel cylinder W/C(FR), and fluid passage 12RL is hydraulically connected to left rear wheel cylinder W/C(RL). Fluid passage 11 and fluid passage 12 constitute a first brake fluid passage. The connecting point between fluid passage 11 and fluid passage 12 is provided with wheel cylinder pressure sensor 9.

Fluid passage 11 is provided with a gate-out valve 13 therein, which is a normally open proportional electromagnetic valve. The p-line fluid passage 11P is provided with master cylinder pressure sensor 5 therein, which is arranged between master cylinder M/C and gate-out valve 13P. Fluid passage 11 is provided with a fluid passage 14, wherein fluid passage 14 and gate-out valve 13 arranged in parallel. Fluid passage 14 is provided with a check valve 15 therein. Check valve 15 is a unidirectional valve that permits brake fluid to flow in a direction from master cylinder M/C to wheel cylinder W/C, and prevents brake fluid from inversely flowing.

Fluid passage 12 is provided with a solenoid in-valve (or inflow valve) 16 therein, which is a normally open proportional electromagnetic valve corresponding to each wheel cylinder W/C. Fluid passage 12 is also provided with a fluid passage 17, wherein solenoid in-valve 16 and fluid passage 17 are arranged in parallel. Fluid passage 17 is provided with a check valve 18 therein, which permits brake fluid to flow in a direction from wheel cylinder W/C to master cylinder M/C, and prevents brake fluid from inversely flowing.

The connecting point between fluid passage 11 and fluid passage 12 is connected to fluid discharge port 10b of pump P by a fluid passage 19. Fluid passage 19 constitutes a second brake fluid passage. Fluid passage 19 is provided with a discharge-side valve 20 therein. Discharge-side valve 20 permits brake fluid to flow in a direction from discharge port 10b to fluid passage 11 and fluid passage 12, and prevents brake fluid from inversely flowing.

The suction port 10a of pump P is connected to a point of fluid passage 11 between master cylinder M/C and gate-out valve 13 by a fluid passage 21. Fluid passage 21 constitutes a third brake fluid passage. Fluid passage 21 is provided with a gate-in valve 23 therein, which is a normally closed electromagnetic valve.

Fluid passage 21 is connected to a section of fluid passage 12 between solenoid in-valve 16 and wheel cylinder W/C by a fluid passage 25 and a fluid passage 22. Fluid passage 25 and fluid passage 22 constitute a fourth brake fluid passage. Fluid passage 25 is provided with a solenoid out-valve (or outflow valve) 26 therein, which is a normally closed electromagnetic valve.

Fluid passage 22 is provided with a reservoir 24 therein, which is between solenoid out-valve 26 and the connecting point between fluid passage 22 and fluid passage 21. Reservoir 24 is provided with a reservoir fluid quantity sensor 27 as a reservoir fluid quantity calculating section for measuring the quantity of brake fluid stored in reservoir 24.

Fluid passage 22 is provided also with a cutoff valve 28 therein, which is a normally closed electromagnetic valve, and is disposed between reservoir 24 and the connecting point between fluid passage 22 and fluid passage 21. Cutoff valve 28 serves as a flow control section for suppressing brake fluid from flowing from reservoir 24 to fluid passage (third brake fluid passage) 21 while the regenerative braking system is operating.

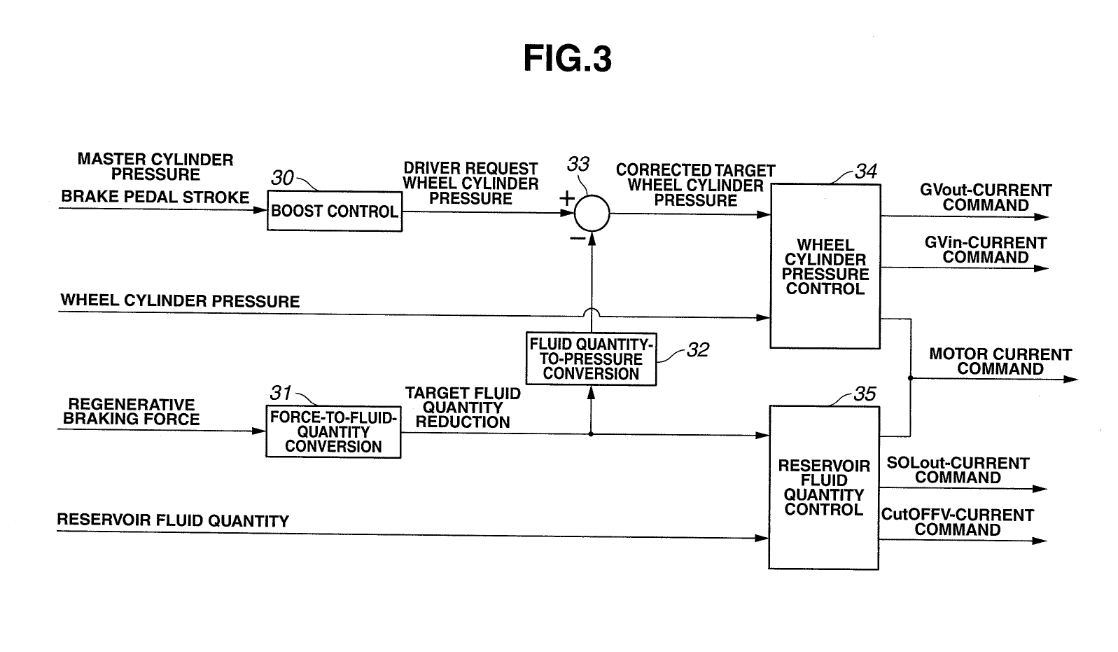

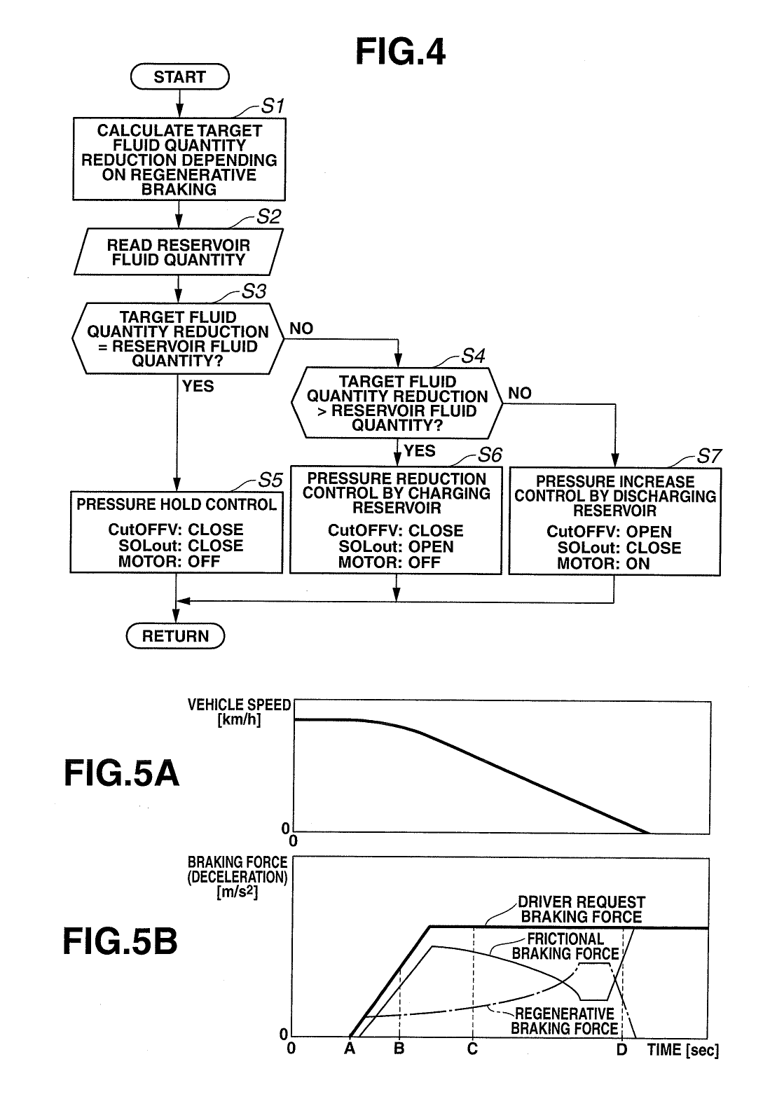

Brake control unit BCU controls the brake fluid pressure by operating the gate-in valves 23, gate-out valves 13, solenoid in-valves 16, solenoid out-valves 26, cutoff valves 28, and electric motor M, based on the brake pedal stroke measured by brake pedal stroke sensor 6, and the condition of braking regeneration of the regenerative braking system composed of motor generator MG, inverter INV and battery BATT. Brake control unit BCU performs PWM-control for gate-out valves 13, solenoid in-valves 16 and electric motor M, and performs on-off control for gate-in valves 23, solenoid out-valves 26 and cutoff valves 28.

<Cooperative Regenerative Braking Control> FIG. 3 shows a function of cooperative regenerative braking control of brake control unit BCU. Brake control unit BCU includes a boost control section 30, a force-to-fluid-quantity converting section 31, a fluid quantity-to-pressure converting section 32, a target wheel cylinder pressure calculating section 33, a wheel cylinder pressure control section 34 and a reservoir fluid quantity control section 35. Boost control section 30 is configured to calculate a driver request braking force (i.e. a driver request value of braking force) based on the measured master cylinder pressure and brake pedal stroke, and calculate a driver request wheel cylinder pressure (i.e. a driver request value of wheel cylinder pressure) of each wheel cylinder based on the calculated driver request braking force, wherein the driver request wheel cylinder pressure is equivalent to the driver request braking force so that the driver request braking force is achieved with the driver request wheel cylinder pressure of each wheel cylinder. Force-to-fluid-quantity converting section 31 is configured to convert a target or actual value of regenerative braking force to an equivalent fluid quantity of brake fluid in wheel cylinder W/C as a target value of fluid quantity reduction. Fluid quantity-to-pressure converting section 32 is configured to calculate and output a corrected value of target wheel cylinder pressure by subtracting a component of target value of fluid quantity reduction from the driver request wheel cylinder pressure. Wheel cylinder pressure control section 34 is configured to conform the wheel cylinder pressure to the corrected target wheel cylinder pressure by feedback control with feedback of measured wheel cylinder pressure, thereby outputting current command signals (GVout current command, GVin current command) to gate-out valves 13 and gate-in valves 23. Reservoir fluid quantity control section 35 is configured to conform the quantity of brake fluid stored in reservoir 24 to the target value of fluid quantity reduction by feedback control with feedback of measured reservoir fluid quantity, thereby outputting current command signals (SOLout current command, CutOFFV current command) to solenoid out-valves 26 and cutoff valves 28.

<Reservoir Fluid Quantity Control> FIG. 4 shows a process of reservoir fluid quantity control performed by brake control unit BCU during the cooperative regenerative braking control. At Step S1, brake control unit BCU allows force-to-fluid-quantity converting section 31 to convert a target or actual value of regenerative braking force to an equivalent fluid quantity of brake fluid in wheel cylinder W/C as a target value of fluid quantity reduction. At Step S2, brake control unit BCU allows reservoir fluid quantity control section 35 to read a measured reservoir fluid quantity obtained by reservoir fluid quantity sensor 27. At Step S3, reservoir fluid quantity control section 35 determines whether or not the target value of fluid quantity reduction is equal to the measured fluid quantity of reservoir 24. When the answer to step S3 is affirmative (YES), then reservoir fluid quantity control section 35 proceeds to Step S5. On the other hand, when the answer to Step S3 is negative (NO), then reservoir fluid quantity control section 35 proceeds to Step S4. At Step S4, reservoir fluid quantity control section 35 determines whether or not the target value of fluid quantity reduction is greater than the measured fluid quantity of reservoir 24. When the answer to step S4 is YES, then reservoir fluid quantity control section 35 proceeds to Step S6. On the other hand, when the answer to Step S4 is NO, then reservoir fluid quantity control section 35 proceeds to Step S7. At Step S5, reservoir fluid quantity control section 35 performs pressure hold control by de-energizing all of cutoff valves 28, solenoid out-valves 26 and electric motor M, and thereby closing the cutoff valves 28, closing the solenoid out-valves 26 and allowing electric motor M to decelerate or remain at rest. At Step S6, reservoir fluid quantity control section 35 performs pressure reduction control by energizing solenoid out-valves 26 and de-energizing the cutoff valves 28 and electric motor M, and thereby closing the cutoff valves 28, opening the solenoid out-valves 26 and allowing electric motor M to decelerate or remain at rest, and thereby allowing brake fluid to be stored in reservoir 24. At Step S7, reservoir fluid quantity control section 35 performs pressure increase control by energizing the cutoff valves 28 and electric motor M and de-energizing the solenoid out-valves 26, and thereby opening the cutoff valves 28, closing the solenoid out-valves 26 and driving the electric motor M, and thereby pumping up brake fluid from reservoir 24.

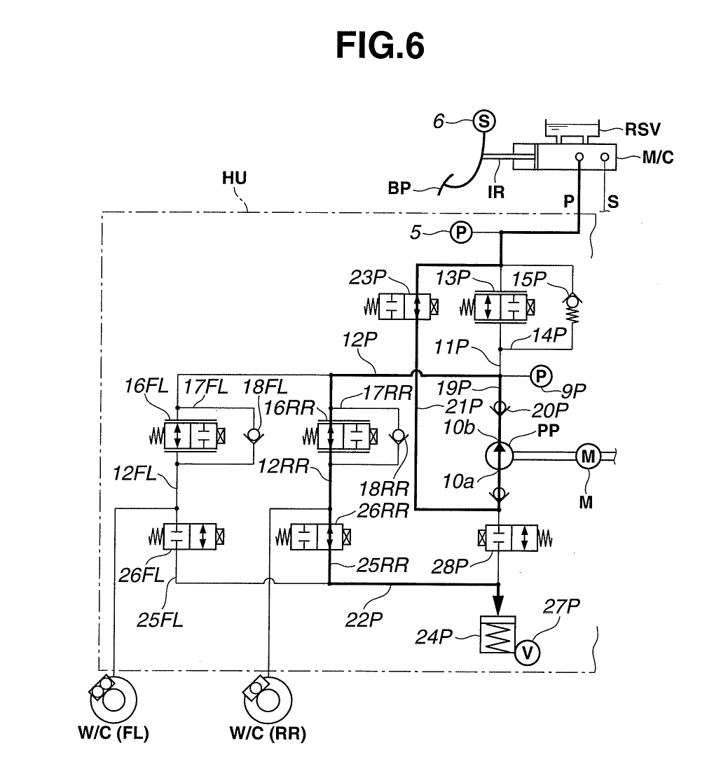

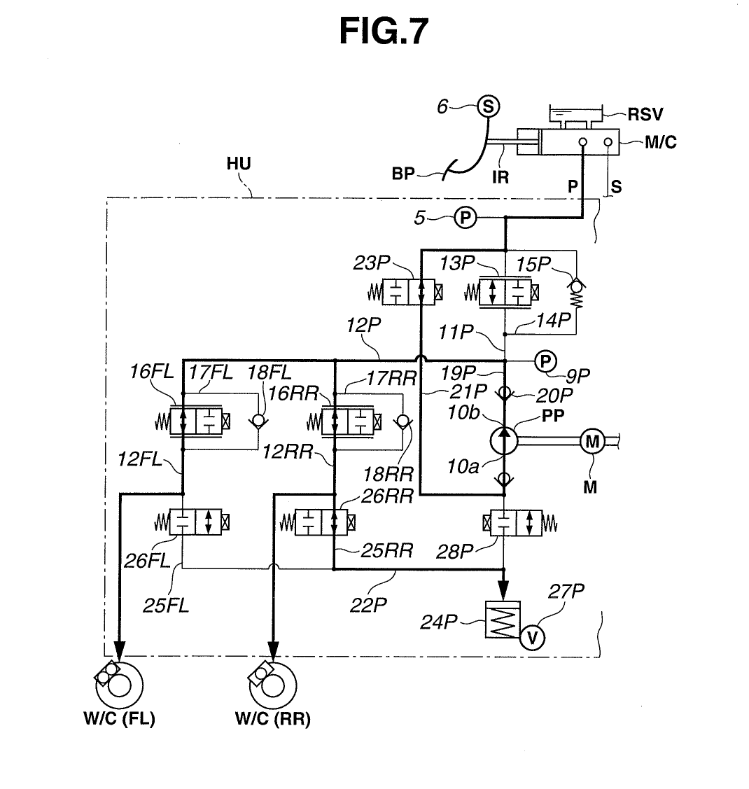

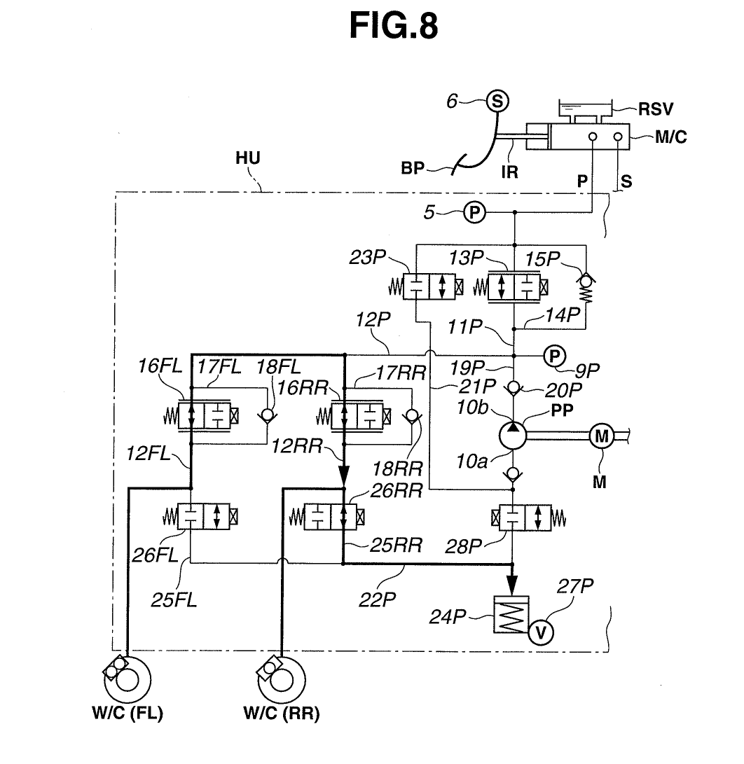

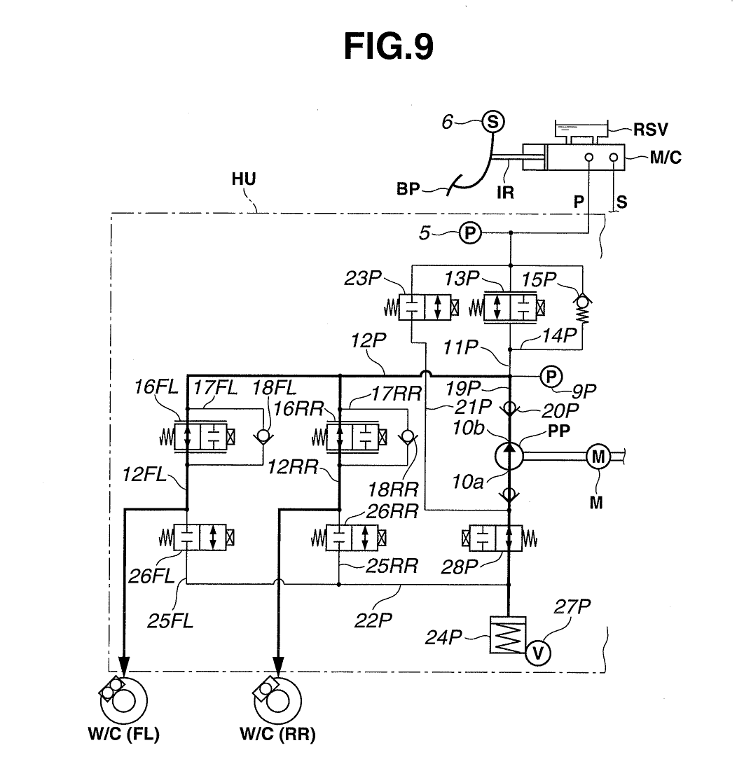

The brake control apparatus described above operates as follows. FIGS. 5A and 5B show how three kinds of braking force (driver request braking force, regenerative braking force and frictional braking force) change with time during a period of time from a time instant when the vehicle is traveling at high speed (for example, at 100 km/h) and brake pedal BP starts to be depressed down by a driver to a time instant when the vehicle comes to a halt. FIGS. 6 to 9 show how hydraulic pressure control unit HU operates and brake fluid flows in the hydraulic circuit in several situations indicated by A, B, C and D in FIG. 5B, which are detailed below. Although FIGS. 6 to 9 are directed to the P-line section, the S-line section operates in the same manner.

<A. At Beginning of Braking Control> FIG. 6 shows how hydraulic pressure control unit HU operates and brake fluid flows in the hydraulic circuit at a beginning of braking operation. At a time instant A where the driver request of braking force starts to rise from zero, brake control unit BCU starts to operate gate-in valves 23 and electric motor M. At this moment, brake control unit BCU covers the driver request of braking force only by regenerative braking force. Accordingly, brake control unit BCU operates solenoid out-valves 26 in the opening direction, and allows a quantity of brake fluid to be stored in reservoir 24, to prevent the wheel cylinder pressures from rising, wherein the quantity of brake fluid is equivalent to the magnitude of regenerative braking force. Then, brake control unit BCU controls the wheel cylinder pressure to be held to produce frictional braking force, by operating gate-out valves 13. The feature that the driver request of braking force is fulfilled only by regenerative braking force at start of braking operation serves to enhance the energy recovery efficiency.

<B. At Increase of Braking Force> FIG. 7 shows how hydraulic pressure control unit HU operates and brake fluid flows in the hydraulic circuit at a stage of increase of braking force. At a time instant B where the driver request of braking force is increasing, brake control unit BCU operates gate-in valves 23 and electric motor M according to the driver request of braking force. At this moment, brake control unit BCU operates solenoid out-valves 26 in an adjusting manner, and allows a quantity of brake fluid to be stored in reservoir 24, wherein the quantity of brake fluid is equivalent to the magnitude of regenerative braking force. Simultaneously, brake control unit BCU controls the wheel cylinder pressure to produce frictional braking force, by operating gate-out valves 13. In this way, brake control unit BCU satisfies the driver request of braking force by combination of regenerative braking force and frictional braking force.

<C. At Increase of Regenerative Braking Force> FIG. 8 shows how hydraulic pressure control unit HU operates and brake fluid flows in the hydraulic circuit at a stage of increase of regenerative braking force. At a time instant C where the driver request of braking force is held constant, brake control unit BCU de-energizes gate-in valves 23 and electric motor M to hold the total braking force to the constant driver request of braking force. At this moment, brake control unit BCU operates solenoid out-valves 26 in an adjusting manner, and allows a quantity of brake fluid to be stored in reservoir 24, wherein the quantity of brake fluid is equivalent to the magnitude of regenerative braking force. Simultaneously, brake control unit BCU controls the wheel cylinder pressure to produce frictional braking force, by operating gate-out valves 13. In this way, brake control unit BCU achieves the driver request of braking force by combination of regenerative braking force and frictional braking force, while reducing the frictional braking force as the regenerative braking force increases, thereby enhancing the energy recovery efficiency.

<D. At Termination of Regenerative Braking> FIG. 9 shows how hydraulic pressure control unit HU operates and brake fluid flows in the hydraulic circuit at a stage of termination of regenerative braking operation. At a time instant D where the driver request of braking force is held constant, brake control unit BCU de-energizes gate-in valves 23 to hold the total braking force to the constant driver request of braking force. At this moment, brake control unit BCU operates cutoff valves 28 in the opening direction and driving the electric motor M to drain brake fluid from reservoir 24 as the regenerative braking force decreases. This results in an increase in wheel cylinder pressure to a suitable level to produce the target frictional braking force satisfying the driver request. Simultaneously, brake control unit BCU energizes and operates gate-out valves 13 to hold the wheel cylinder pressures and thereby hold the frictional braking force. In this way, brake control unit BCU carries out replacement of regenerative braking force with frictional braking force while satisfying the driver request of braking force.

As described above, the brake control apparatus disclosed in Japanese Patent Application Publication 2002-302031 implements a brake boost function with two control valves for switching between two fluid passages leading to wheel cylinders, wherein one of the fluid passages is provided with a boost piston for boosting pressure of brake fluid discharged by a pump, and the other fluid passage is provided with no such boost piston. This structure tends to lead to an increased number of parts, and an increased complexity of structure, and thereby an increased manufacturing cost. In contrast, the brake control apparatus according to the present embodiment is based on a basic control unit as used to implement ABS control or vehicle dynamic behavior control, and is configured by addition of the sensors (brake pedal stroke sensor 6, wheel cylinder pressure sensor 9 and reservoir fluid quantity sensor 27) and replacement of a check valve at a suction side of a pump with an electromagnetic valve (cutoff valve 28). Hydraulic pressure control unit HU of this embodiment implements a boost function of achieving a desired boost ratio by setting the driver request wheel cylinder pressure above the master cylinder pressure, and actively increasing the brake fluid pressure by operating the pump P and suitably operating the gate-out valves 13 and gate-in valves 23 to conform the wheel cylinder pressure to the driver request wheel cylinder pressure (or the corrected target wheel cylinder pressure after correction in account of regenerative braking when regenerative braking force is outputted).

Hydraulic pressure control unit HU of this embodiment contributes to cooperative regenerative braking control by setting the corrected target wheel cylinder pressure by subtracting from the driver request wheel cylinder pressure a component equivalent to the regenerative braking force, and controlling the pumps P, gate-out valves 13 and gate-in valves 23 by feedback control to conform the measured value of wheel cylinder pressure obtained by wheel cylinder pressure sensor 9 to the corrected target wheel cylinder pressure, and simultaneously controlling the pumps P, solenoid out-valves 26 and cutoff valves 28 to conform the measured value of reservoir fluid quantity obtained by reservoir fluid quantity sensor 27 to the value equivalent to the regenerative braking force.

In this way, the brake control apparatus of this embodiment is capable of implementing a boost function and contributing to a cooperative regenerative braking control system with a simple structure which is advantageous in reducing the manufacturing cost. The reduction in manufacturing cost is also contributed by construction based on an existing structure of hydraulic pressure control unit.

The feature of hydraulic pressure control unit HU that fluid passage 21 is provided with gate-in valve 23 therein serves to suppress the suction side of pump P from being subject to high pressure resulting from depression of brake pedal BP, and thereby improve the endurance of pump P. The capability of precisely controlling the brake fluid pressure on the suction side of pump P allows to set slightly lower the pressure of a first section of fluid passage 21 than the pressure of a second section of fluid passage 21, wherein the first section is between gate-in valve 23 and pump P, and the second section is between gate-in valve 23 and master cylinder M/C.

The feature that brake control unit BCU controls the brake fluid pressure by operating the valves 13, 16, 23, 26 and 28 and pumps P depending on the master cylinder pressure, brake pedal stroke and regenerative braking force, makes it possible to output an optimal frictional braking force conformed to the combination of the master cylinder pressure, brake pedal stroke and regenerative braking force.

The feature that brake control unit BCU opens solenoid out-valves 26 when regenerative braking force is being produced, serves to allow a quantity of brake fluid to be stored in reservoir 24 wherein the quantity is equivalent to the produced regenerative braking force. In this situation, cutoff valve 28, which is disposed in a section of fluid passage 22 between reservoir 24 and the connecting portion between fluid passage 22 and fluid passage 21, is closed. This serves to prevent the brake fluid flown into reservoir 24 from being sucked by pump P.

The feature that brake control unit BCU achieves a desired braking force by allocating the driver request of braking force between regenerative braking force and frictional braking force by operating the solenoid out-valve 26 in the opening direction and thereby distributing to wheel cylinder W/C and reservoir 24 brake fluid flown out of master cylinder M/C, serves to allow the driver request of braking force to be satisfied by combination of regenerative braking force and frictional braking force.

The feature that solenoid out-valve 26 is implemented by a proportional type electromagnetic valve serves to allow precise control of the quantity of brake fluid stored in reservoir 24.

The provision of reservoir fluid quantity sensor 27 for measuring the quantity of brake fluid stored in reservoir 24 serves to allow accurate measurement of the quantity of brake fluid stored in reservoir 24, and allow a suitable quantity of brake fluid to be stored in reservoir 24 which is equivalent to the regenerative braking force.

The feature that the vehicle includes the P-line section and S-line section, wherein left front road wheel FL and right rear road wheel RR belong to the P-line section, and wherein right front road wheel FR and left rear road wheel RL belong to the S-line section; each of the line sections includes an independent set of the first, second and third brake fluid passages (11, 12, 19, 21), the pump P, the reservoir 24 and the cutoff valve 28; and each of the four road wheels is provided with an independent set of the wheel cylinder W/C, solenoid in-valve 16, solenoid out-valve 26 and the fourth brake fluid passage (22, 25), serves to allow generation of braking force by one of the line sections even when the other line section is failed, although the upper limit of braking force is half the normal upper limit based on two normal line sections.

The following summarizes the technical features of the brake control apparatus described above, and advantageous effects produced by the brake control apparatus.

<1> A brake control apparatus for a vehicle provided with a regenerative braking system (motor generator MG, inverter INV and battery BATT), the brake control apparatus includes: a braking operation detecting section (master cylinder pressure sensor 5 for detecting master cylinder pressure, and brake pedal stroke sensor 6 for detecting stroke of brake pedal BP) configured to detect a condition of driver's braking operation; a first brake fluid passage (fluid passages 11, 12) hydraulically connecting a master cylinder (M/C) to a wheel cylinder (W/C), wherein the master cylinder (M/C) generates a brake fluid pressure in response to driver's braking operation, and wherein the brake fluid pressure acts on the wheel cylinder (W/C); a pump (P) configured to suck brake fluid from the master cylinder (M/C), and provided with a discharge-side valve (20) on a discharge side (discharge port 10b) of the pump (P); a second brake fluid passage (fluid passage 19) hydraulically connecting the discharge side (10b) of the pump (P) to a first connecting portion of the first brake fluid passage (11, 12); a third brake fluid passage (fluid passage 21) hydraulically connecting a suction side (suction port 10a) of the pump (P) to a second connecting portion of the first brake fluid passage (11, 12), wherein the second connecting portion is between the master cylinder (M/C) and the first connecting portion; an inflow valve (solenoid in-valve 16) disposed in a section of the first brake fluid passage (11, 12) between the wheel cylinder (W/C) and the first connecting portion of the first brake fluid passage (11, 12); a fourth brake fluid passage (fluid passages 22, 25) hydraulically connecting a connecting portion of the third brake fluid passage (21) to a third connecting portion of the first brake fluid passage (11, 12), wherein the third connecting portion is between the inflow valve (16) and the wheel cylinder (W/C); an outflow valve (solenoid out-valve 26) disposed in the fourth brake fluid passage (22, 25); a reservoir (24) disposed in a section of the fourth brake fluid passage (22, 25) between the outflow valve (26) and the connecting portion of the third brake fluid passage (21); and a cutoff valve (28) disposed in a section of the fourth brake fluid passage (22, 25) between the reservoir (24) and the connecting portion of the third brake fluid passage (21), and configured to operate depending on a condition of operation of the regenerative braking system (MG, INV, BATT). This feature serves to achieve a boost function and conform to cooperative regenerative braking based on pump operation, with a simple structure for cost reduction.

<2> The brake control apparatus further includes a solenoid valve (gate-in valve 23) disposed in the third brake fluid passage (21). This feature prevents the suction side of pump P from being subject to high pressure, and thereby enhances the endurance of pump P. The capability of precisely controlling the brake fluid pressure on the suction side of pump P allows to set slightly lower the pressure of a first section of fluid passage 21 than the pressure of a second section of fluid passage 21, wherein the first section is between gate-in valve 23 and pump P, and the second section is between gate-in valve 23 and master cylinder M/C. This feature further prevents the suction side of pump P from being subject to high pressure, and thereby enhances the endurance of pump P.

<3> The brake control apparatus further includes a brake fluid pressure control section (brake control unit BCU) configured to control the brake fluid pressure by operating at least one of the inflow valve (solenoid in-valve 16), the outflow valve (solenoid out-valve 26), the cutoff valve (28) and the pump (P), based on the detected condition of driver's braking operation and a condition of brake regeneration of the regenerative braking system (MG, INV, BATT). This feature serves to output an optimal output of frictional braking force depending on master cylinder pressure, brake pedal stroke and regenerative braking force.

<4> The brake control apparatus is configured so that the cutoff valve (28) is configured to restrict a quantity of brake fluid flowing from the reservoir (24) into the pump (P). This feature serves to prevent brake fluid from being sucked from reservoir 24 by pump P.

<5> The brake control apparatus is configured so that the brake fluid pressure control section (brake control unit BCU) is configured to store in the reservoir (24) brake fluid flown out of the master cylinder (M/C), by operating the inflow valve (solenoid in-valve 16) in an opening direction and operating the outflow valve (solenoid out-valve 26) in an opening direction and operating the cutoff valve (cutoff valve 28) in a closing direction, while detecting presence of driver's braking operation by the braking operation detecting section (master cylinder pressure sensor 5, brake pedal stroke sensor 6) and presence of brake regeneration of the regenerative braking system (MG, INV, BATT). This feature serves to store in reservoir 24 a quantity of brake fluid equivalent to regenerative braking force, and thereby enhance energy recovery efficiency.

### Second Embodiment

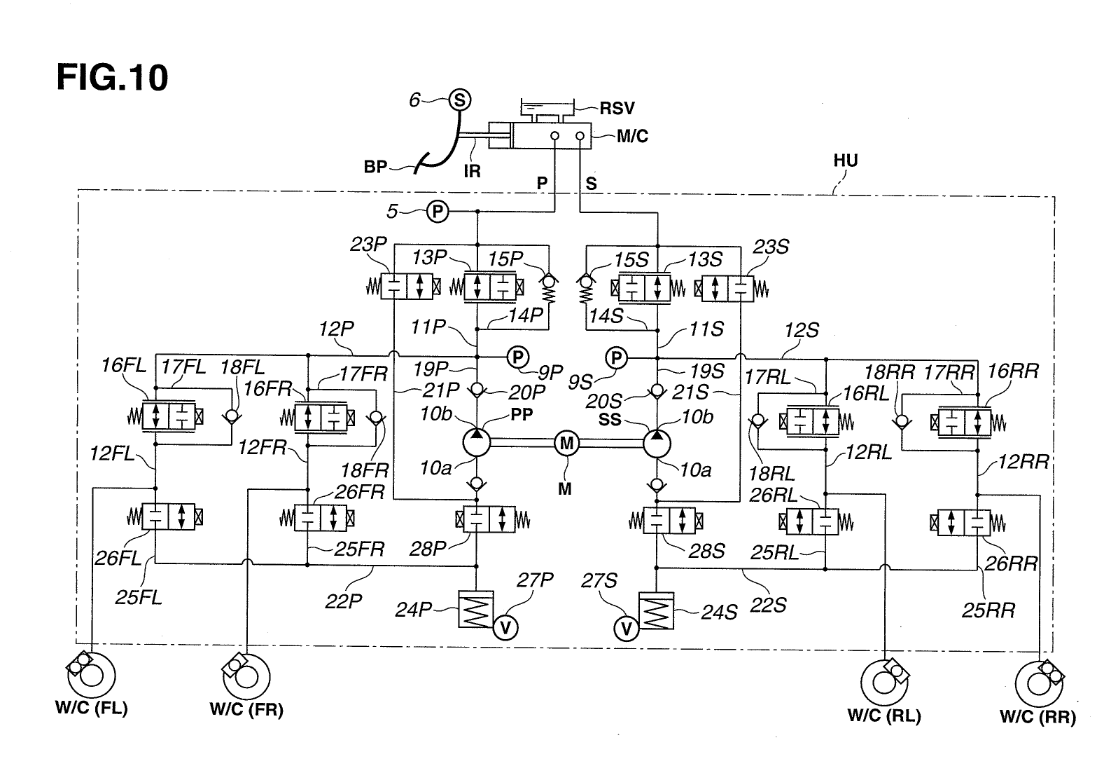

FIG. 10 shows a hydraulic circuit of a brake control apparatus according to a second embodiment of the present invention. The second embodiment differs from the first embodiment in that hydraulic pressure control unit HU is based on the so-called H-line arrangement instead of X-line arrangement. Specifically, hydraulic pressure control unit HU includes a P-line section and a S-line section, wherein left front road wheel FL and right front road wheel FR belong to the P-line section, and left rear road wheel RL and right rear road wheel RR belong to the S-line section. Except for those features, the brake control apparatus of the second embodiment is configured similarly as in the first embodiment. This brake control apparatus is advantageous in producing equal braking forces at the left side and the right side when using one of the P-line section and S-line section because of failure of the other. This feature serves to suppress dynamic behavior of the vehicle from falling unstable at braking.

The brake control apparatus may be configured so that: the vehicle includes a first line section and a second line section, wherein a first road wheel set under control of the regenerative braking system belongs to the first line section, and wherein a second road wheel set other than the first road wheel set belongs to the second line section; and the cutoff valve is provided only in the first line section. This serves to store in the reservoir of the first line section a suitable quantity of brake fluid supplied to the wheel cylinders of the first line section, while keeping the braking forces of all of the wheels in balance.

### Third Embodiment

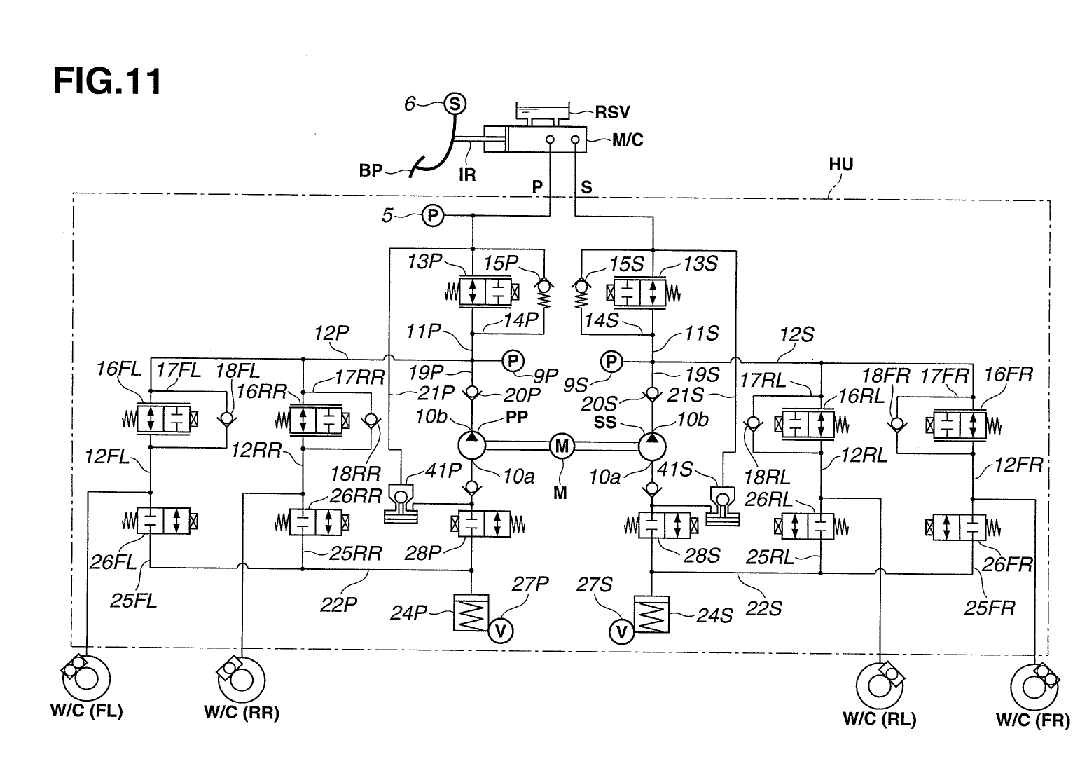

FIG. 11 shows a hydraulic circuit of a brake control apparatus according to a third embodiment of the present invention. The third embodiment differs from the first embodiment in that hydraulic pressure control unit HU includes a pressure regulator valve 41 instead of gate-in valve 23 shown in FIG. 2. Specifically, pressure regulator valve 41 is a unidirectional valve disposed in fluid passage 21, and is configured to be closed in response to a condition that the pressure of brake fluid on the master cylinder side of pressure regulator valve 41 is higher than that on the pump side of pressure regulator valve 41, and opened in response to a condition that the pressure on the suction side of pump P becomes a negative pressure. Except for those features, the brake control apparatus according to the second embodiment is configured similarly as in the first embodiment. The provision of pressure regulator valve 41 serves to prevent the suction side of pump P from being subject to high pressure, and thereby improve the endurance of pump P, as in the case of gate-in valve 23 in the first embodiment. The removal of two gate-in valves 23P, 23S which are electromagnetic valves serves to reduce the manufacturing cost. The brake control apparatus may be constructed based on an existing hydraulic pressure control unit in which a pressure regulator reservoir is provided instead of a gate-in valve, by separating and allocating two functions (reservoir function, and pressure regulator function) to reservoir 24 and pressure regulator valve 41, and providing cutoff valve 28 between reservoir 24 and pressure regulator valve 41.

### Fourth Embodiment

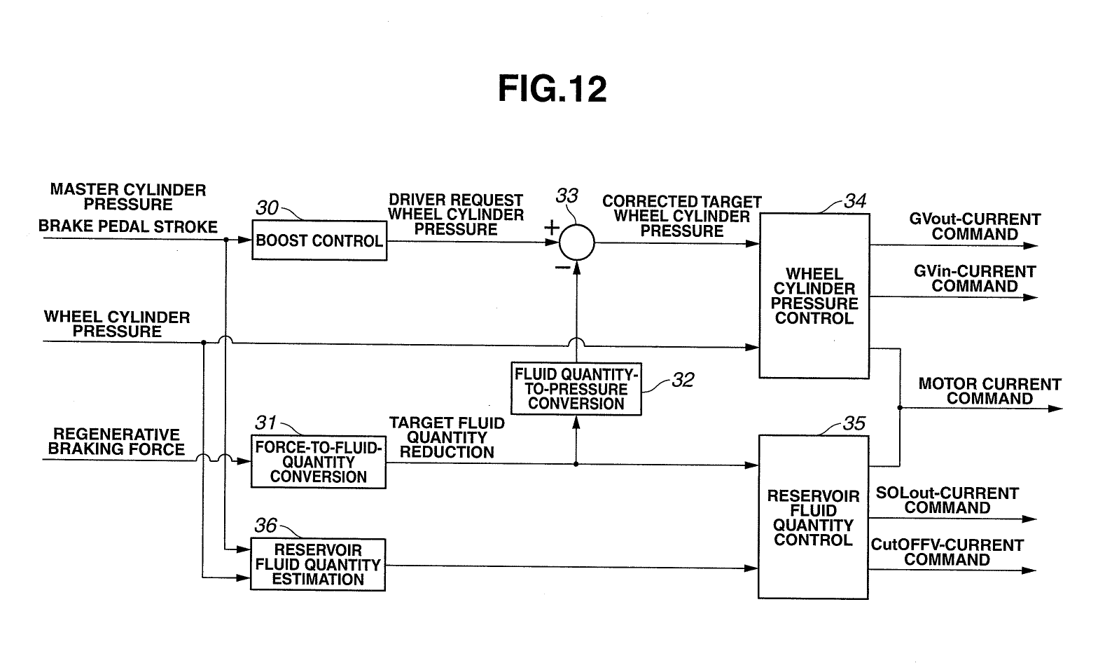

FIG. 12 shows a function of cooperative regenerative braking control of a brake control unit of a brake control apparatus according to a fourth embodiment of the present invention. This brake control unit BCU differs from that of the first embodiment in that brake control unit BCU includes a reservoir fluid quantity estimating section 36 for estimating the quantity of brake fluid stored in reservoir 24. Reservoir fluid quantity estimating section 36 is configured to calculate an estimated value of the quantity of brake fluid stored in reservoir 24, based on master cylinder pressure, brake pedal stroke, and wheel cylinder pressure. It is because hydraulic pressure control unit HU is based on a closed hydraulic circuit that this estimation can be suitably performed. The ability of estimating the reservoir fluid quantity without sensor information allows to further reduce the manufacturing cost.

<Modifications> The present embodiments may be modified variously. For example, although the first embodiment is an example applied to an electric hybrid vehicle, the brake control apparatus described above may be applied to any other vehicle provided with a regenerative braking system, such as electric vehicles, for producing similar advantageous effects as in the present embodiments. Although all of the driver request braking force, regenerative braking force, and frictional braking force are determined by brake control unit BCU in the foregoing embodiments, the driver request braking force and regenerative braking force may be determined and sent to brake control unit BCU by another control unit.

The entire contents of Japanese Patent Application 2011-143648 filed Jun. 29, 2011 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A brake control apparatus for a vehicle provided with a regenerative braking system, the brake control apparatus comprising:
a braking operation detecting section configured to detect a condition of driver's braking operation;
a first brake fluid passage hydraulically connecting a master cylinder to a wheel cylinder, wherein the master cylinder generates a brake fluid pressure in response to driver's braking operation, and wherein the brake fluid pressure acts on the wheel cylinder;
a pump configured to suck brake fluid from the master cylinder, and provided with a discharge-side valve on a discharge side of the pump;
a second brake fluid passage hydraulically connecting the discharge side of the pump to a first connecting portion of the first brake fluid passage;
a third brake fluid passage hydraulically connecting a suction side of the pump to a second connecting portion of the first brake fluid passage, wherein the second connecting portion is between the master cylinder and the first connecting portion;
an inflow valve disposed in a section of the first brake fluid passage between the wheel cylinder and the first connecting portion of the first brake fluid passage;
a fourth brake fluid passage hydraulically connecting a connecting portion of the third brake fluid passage to a third connecting portion of the first brake fluid passage, wherein the third connecting portion is between the inflow valve and the wheel cylinder;
an outflow valve disposed in the fourth brake fluid passage;
a reservoir disposed in a section of the fourth brake fluid passage between the outflow valve and the connecting portion of the third brake fluid passage; and
a cutoff valve disposed in a section of the fourth brake fluid passage between the reservoir and the connecting portion of the third brake fluid passage, and configured to operate depending on a condition of operation of the regenerative braking system.

2. The brake control apparatus as claimed in claim 1, further comprising a solenoid valve disposed in the third brake fluid passage.

3. The brake control apparatus as claimed in claim 2, further comprising a brake fluid pressure control section configured to control the brake fluid pressure by operating at least one of the inflow valve, the outflow valve, the cutoff valve and the pump, based on the detected condition of driver's braking operation and a condition of brake regeneration of the regenerative braking system.

4. The brake control apparatus as claimed in claim 3, wherein the cutoff valve is configured to restrict a quantity of brake fluid flowing from the reservoir into the pump.

5. The brake control apparatus as claimed in claim 4, wherein the brake fluid pressure control section is configured to store in the reservoir brake fluid flown out of the master cylinder, by operating the inflow valve in an opening direction and operating the outflow valve in an opening direction and operating the cutoff valve in a closing direction, while detecting presence of driver's braking operation by the braking operation detecting section and presence of brake regeneration of the regenerative braking system.

6. The brake control apparatus as claimed in claim 5, wherein the brake fluid pressure control section is configured to achieve a desired braking force by distributing between the wheel cylinder and the reservoir brake fluid flown out of the master cylinder, by operating the outflow valve in the opening direction.

7. The brake control apparatus as claimed in claim 6, wherein the outflow valve is a proportional electromagnetic valve.

8. The brake control apparatus as claimed in claim 5, further comprising a reservoir fluid quantity calculating section configured to calculate a quantity of brake fluid stored in the reservoir.

9. The brake control apparatus as claimed in claim 8, wherein the reservoir fluid quantity calculating section includes a reservoir fluid quantity sensor configured to measure the quantity of brake fluid stored in the reservoir.

10. The brake control apparatus as claimed in claim 1, further comprising a unidirectional valve disposed in the third brake fluid passage and configured to suppress brake fluid from flowing into the suction side of the pump by being closed by brake fluid flown out of the master cylinder.

11. The brake control apparatus as claimed in claim 1, wherein:
the vehicle includes a first line section and a second line section, wherein a left front road wheel and a right rear road wheel belong to the first line section, and wherein a right front road wheel and a left rear road wheel belong to the second line section;
each of the first and second line sections includes an independent set of the first, second and third brake fluid passages, the pump, the reservoir and the cutoff valve; and
each of the four road wheels is provided with an independent set of the wheel cylinder, the inflow valve, the outflow valve and the fourth brake fluid passage.

12. The brake control apparatus as claimed in claim 1, wherein:
the vehicle includes a first line section and a second line section, wherein a left front road wheel and a right front road wheel belong to the first line section, and wherein a left rear road wheel and a right rear road wheel belong to the second line section;
each of the first and second line sections includes an independent set of the first, second and third brake fluid passages, the pump, the reservoir and the cutoff valve; and
each of the four road wheels is provided with an independent set of the wheel cylinder, the inflow valve, the outflow valve and the fourth brake fluid passage.

13. The brake control apparatus as claimed in claim 1, wherein:
the vehicle includes a first line section and a second line section, wherein a first road wheel set under control of the regenerative braking system belongs to the first line section, and wherein a second road wheel set other than the first road wheel set belongs to the second line section; and
the cutoff valve is provided in the first line section.

14. A brake control apparatus for a vehicle provided with a regenerative braking system, the brake control apparatus comprising:
a braking operation detecting section configured to detect a condition of driver's braking operation;
a first brake fluid passage hydraulically connecting a master cylinder to a wheel cylinder, wherein the master cylinder generates a brake fluid pressure in response to driver's braking operation, and wherein the brake fluid pressure acts on the wheel cylinder;
a pump configured to suck brake fluid from the master cylinder, and provided with a discharge-side valve on a discharge side of the pump;
a second brake fluid passage hydraulically connecting the discharge side of the pump to a first connecting portion of the first brake fluid passage;
a third brake fluid passage hydraulically connecting a suction side of the pump to a second connecting portion of the first brake fluid passage, wherein the second connecting portion is between the master cylinder and the first connecting portion;
an inflow valve disposed in a section of the first brake fluid passage between the wheel cylinder and the first connecting portion of the first brake fluid passage;
a fourth brake fluid passage hydraulically connecting a connecting portion of the third brake fluid passage to a third connecting portion of the first brake fluid passage, wherein the third connecting portion is between the inflow valve and the wheel cylinder;
an outflow valve disposed in the fourth brake fluid passage;
a reservoir disposed in a section of the fourth brake fluid passage between the outflow valve and the connecting portion of the third brake fluid passage, and configured to receive inflow of brake fluid flown out of the master cylinder through the inflow valve and the outflow valve; and
a cutoff valve disposed in a section of the fourth brake fluid passage between the reservoir and the connecting portion of the third brake fluid passage, and configured to allow the reservoir to store brake fluid flown into the reservoir, by cutting off hydraulic connection between the reservoir and the third brake fluid passage.

15. The brake control apparatus as claimed in claim 14, further comprising a solenoid valve disposed in the third brake fluid passage.

16. The brake control apparatus as claimed in claim 15, further comprising a brake fluid pressure control section configured to control the brake fluid pressure by operating at least one of the inflow valve, the outflow valve, the cutoff valve and the pump, based on the detected condition of driver's braking operation and a condition of brake regeneration of the regenerative braking system.

17. The brake control apparatus as claimed in claim 16, further comprising a unidirectional valve disposed in the third brake fluid passage and configured to suppress brake fluid from flowing into the suction side of the pump by being closed by brake fluid flown out of the master cylinder.

18. A brake control apparatus for a vehicle provided with a regenerative braking system, the brake control apparatus comprising:
a braking operation detecting section configured to detect a condition of driver's braking operation;
a first brake fluid passage hydraulically connecting a master cylinder to a wheel cylinder, wherein the master cylinder generates a brake fluid pressure in response to driver's braking operation, and wherein the brake fluid pressure acts on the wheel cylinder;
a pump configured to suck brake fluid from the master cylinder, and provided with a discharge-side valve on a discharge side of the pump;
a second brake fluid passage hydraulically connecting the discharge side of the pump to a first connecting portion of the first brake fluid passage;
a third brake fluid passage hydraulically connecting a suction side of the pump to a second connecting portion of the first brake fluid passage, wherein the second connecting portion is between the master cylinder and the first connecting portion;
an inflow valve disposed in a section of the first brake fluid passage between the wheel cylinder and the first connecting portion of the first brake fluid passage;
a fourth brake fluid passage hydraulically connecting a connecting portion of the third brake fluid passage to a third connecting portion of the first brake fluid passage, wherein the third connecting portion is between the inflow valve and the wheel cylinder;
an outflow valve disposed in the fourth brake fluid passage;
a reservoir disposed in a section of the fourth brake fluid passage between the outflow valve and the connecting portion of the third brake fluid passage, and configured to receive inflow of brake fluid flown out of the master cylinder through the inflow valve and the outflow valve; and
a flow control section configured to suppress brake fluid from flowing out of the reservoir to the third brake fluid passage, in response to presence of operation of the regenerative braking system.

19. The brake control apparatus as claimed in claim 18, wherein the flow control section includes a cutoff valve disposed in a section of the fourth brake fluid passage between the reservoir and the connecting portion of the third brake fluid passage, and configured to cut off hydraulic connection between the reservoir and the third brake fluid passage.

20. The brake control apparatus as claimed in claim 18, further comprising a brake fluid pressure control section configured to control the brake fluid pressure by operating at least one of the inflow valve, the outflow valve and the pump, based on the detected condition of driver's braking operation and a condition of brake regeneration of the regenerative braking system.
